(19) United States
(12) Patent Application Publication
(10) Pub. No.: US 2002/0051699 A1
(43) Pub. Date: May 2, 2002

(54) Door system for a process chamber

(76) Inventors: Gordon Nelson, Kalispell, MT (US); Jeffry A. Davis, Kalispell, MT (US)

Correspondence Address: LYON & LYON LLP, 633 WEST FIFTH STREET, SUITE 4700, LOS ANGELES, CA, 90071, US

(21) Appl. No.: 09/905,677

(22) Filed: Jul. 13, 2001

Related U.S. Application Data
(63) Continuation-in-part of application No. 09/274,511, filed on Mar. 23, 1999.
Application No. 09/274,511 is a continuation-in-part of application No. 09/112,259, filed on Jul. 8, 1998.
Application No. 09/112,259 is a continuation-in-part of application No. 08/994,737, filed on Dec. 19, 1997.
Application No. 08/994,737 is a continuation-in-part of application No. 08/851,480, filed on May 5, 1997, now abandoned.
Application No. 08/994,737 is a continuation-in-part of application No. 09/612,009, filed on Jul. 7, 2000.

(51) Int. Cl. B65G 1/00

(52) U.S. Cl. 414/217.1

(57) ABSTRACT

A processor has a door system for opening and closing a process chamber. The door system includes a closure plate on an actuator supported by a mounting plate. The actuator moves the closure plate into engagement with an open front end of the chamber, to seal the chamber. Lift actuators raise and lower the mounting plate carrying the closure plate between a loading position and a chamber engagement position. The mounting plate has a center section supporting the closure plate actuator, and narrower legs extending from the center section to the lift actuators. A separate door cover is attached to the mounting plate. Visual inspection of the alignment of the closure plate and chamber is improved, better facilitating manufacture and maintenance of the processor. The lift actuators preferably have a piston within a cylinder magnetically coupled to the mounting plate, to reduce or eliminate leakage from the cylinders.

This application is Continuation-in-Part of U.S. patent application Ser. No. 09/274,511, filed Mar. 23, 1999 and now pending, which is a Continuation-in-Part of U.S. patent application Ser. No. 09/112,259, filed Jul. 8, 1998, and now pending, which is a Continuation-in-Part of U.S. patent application Ser. No. 08/994,737, filed Dec. 19, 1997, and now pending, which is a Continuation-in-Part of U.S. patent application Ser. No. 08/851,480, filed May 5, 1997 and now abandoned. This Application is also a Continuation-in-Part of U.S. patent application Ser. No. 09/612,009, filed Jul. 7, 2000 and now pending. Priority to these applications is claimed under 35 USC §120, and these applications are incorporated herein by reference.

The field of the invention is automated workpiece processing systems, used for processing workpieces, such as semiconductor wafers, hard disk media, substrates, optical materials, as well as other workpieces formed from a substrate upon which microelectronic circuits or components, data storage elements or layers, and/or micro-mechanical elements are or can be formed. These and similar materials generally requiring very low levels of contamination, are collectively referred to here as “wafers” or “workpieces”.

### BACKGROUND OF THE INVENTION

Computers, televisions, telephones and other electronic product contain large numbers of essential electronic semiconductor devices. To produce electronic products, hundreds or thousands of semiconductor devices are manufactured in a very small space, using lithography techniques on semiconductor substrates, such as on silicon wafers or other substrates. Due to the extremely small dimensions involved in manufacturing semiconductor devices, contaminants on the semiconductor substrate material, such as particles of dust, dirt, paint, metal, etc. lead to defects in the end products.

Existing automated semiconductor processing system use robots, carriers, rotors, and other devices, to move and process wafers. Many automated semiconductor processing systems use centrifugal wafer processors, which spin the wafers at high speed, while spraying or otherwise applying process fluids and/or gases onto the wafers. The rotors typically hold a batch of wafers in a parallel array. Other types of processors have a fixed or rotating workpiece support holding workpieces within a chamber. Process fluids, such as liquids, gases or vapors are introduced into the chamber to process the workpieces. The chamber typically has an open front end, side, or surface, which is closed off or sealed off by a door. The door is opened, or temporarily displaced or removed, during loading and unloading of workpieces into or out of the chamber. The door is closed or engaged during processing of the workpieces, to contain the process fluids within the chamber. Generally, the door must be aligned with the chamber opening, during manufacture and during servicing or maintenance. However, this procedure may be difficult to perform as the structure of the door can obstruct visual inspection of the position or fit of the door in the chamber opening. In addition, actuators used to move the door may create the potential for contamination. Accordingly, there is a need for improved door systems and methods for workpiece process chambers.

### SUMMARY OF THE INVENTION

In a first aspect, a processor for processing a workpiece with fluids includes a chamber or bowl having an opening to allow workpieces to be loaded into and unloaded from the chamber. A door system seals off, or at least closes off, the opening of the chamber, during processing of the workpieces. The door system moves away from the opening of the chamber, to provide access into the chamber, for loading and unloading workpieces. The door system advantageously includes a seal or closure plate and a closure plate actuator supported on a mounting plate. The mounting plate is preferably attached to lift actuators which move the mounting plate from a first position, where the closure plate is aligned with the opening of the chamber, to a second position where the closure plate is moved away from the chamber, preferably below the chamber. A cover on the mounting plate covers the mounting plate, the closure plate actuator and the closure plate. The cover is quickly and easily removable for servicing the door system.

In a second and separate aspect, the mounting plate has a narrow profile or reduced height, to better facilitate visual inspection, adjustment, and servicing of the door system.

In a third aspect, the mounting plate has first and second legs extending outwardly from opposite sides of a center section. Each leg is attached to a lift actuator. Each lift actuator advantageously has a piston within a cylinder magnetically coupled to a piston follower outside of the cylinder and linked to the mounting plate.

It is an object of the invention to provide an improved door system for a workpiece processor. Other objects and advantages may appear below. The invention resides as well in subcombinations of the features, elements and steps described. The door system may be used on a stand alone processor, or as part of an apparatus having multiple processors or workpiece handling elements.

### DETAILED DESCRIPTION

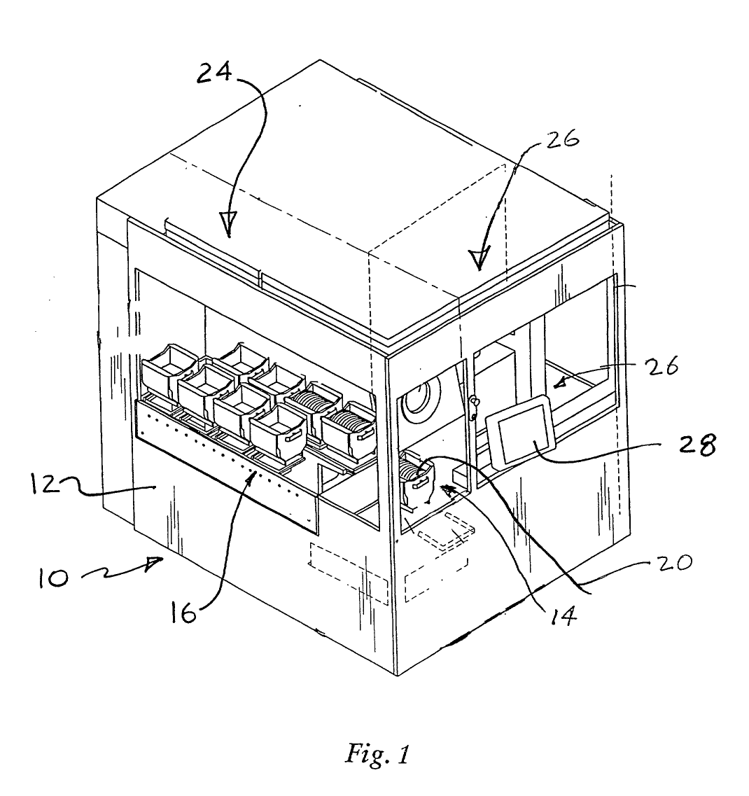

As shown in FIG. 1, a process system 10 for processing workpieces 20 includes an input/output station 14, an indexer or workpiece storage location 16, an interface section 24 and a process section 26, within an enclosure 12. A process robot 22 moves from the interface section 24 to the process section 26, to carry one or more workpieces 20 from the indexer 16, or other storage location, to one or more processors 30 in the process section 26. Preferably, a computer/controller 32, optionally linked to a facility computer/controller, controls movement of components and workpieces within the enclosure 12. A control panel 28 may also be provided to monitor and/or control the process system 10.

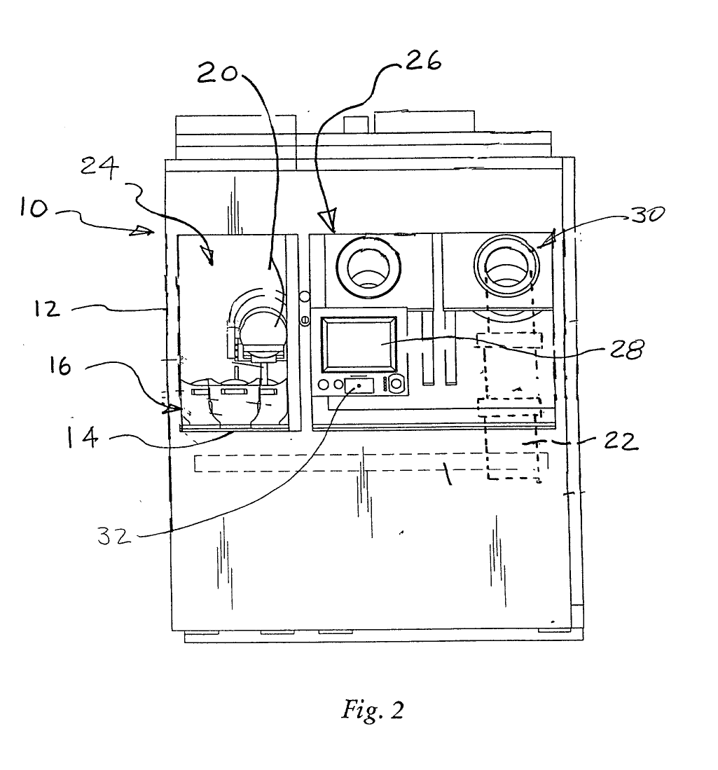

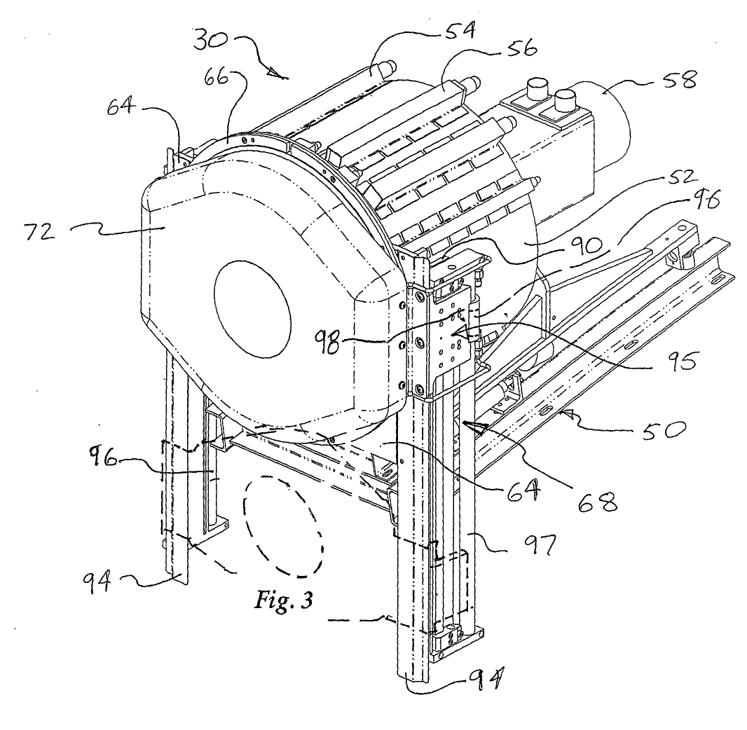

Referring to FIGS. 3 and 4, the processor(s) 30 includes a chamber or bowl 52 supported on a chassis 50. Liquid and gas or vapor spray manifolds 54 and 56 introduce process fluids into the chamber 52 during processing of workpieces. The workpieces are typically held in a rotor 60 driven by a spin motor 58. A seal 62 around the shaft of the motor 58 reduces or prevents fluids from leaking out of the back of the chamber 52 through the shaft opening. A support ring 66 around the front open end of the chamber 52 is attached to support plates 64.

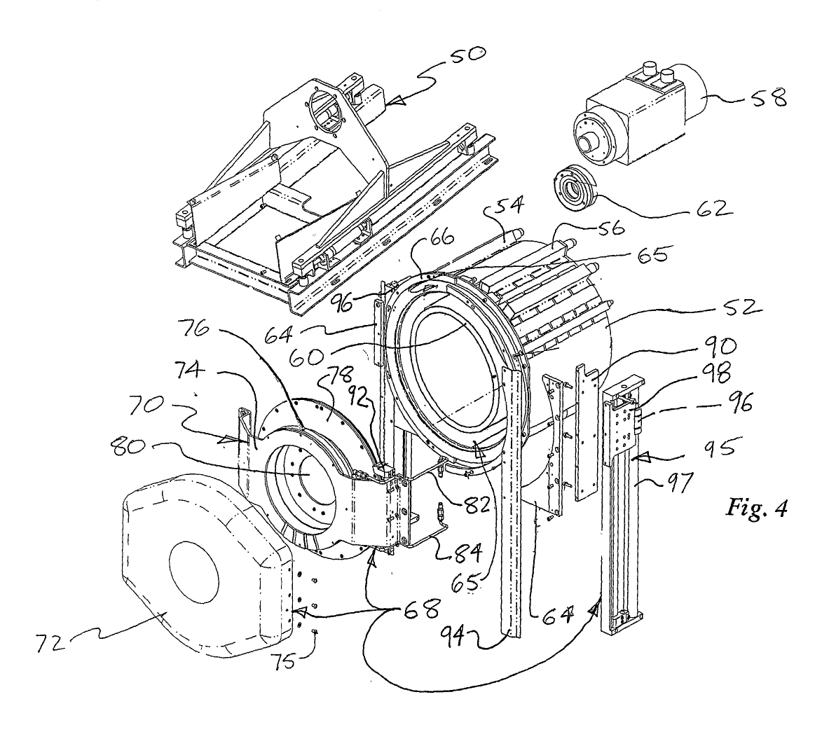

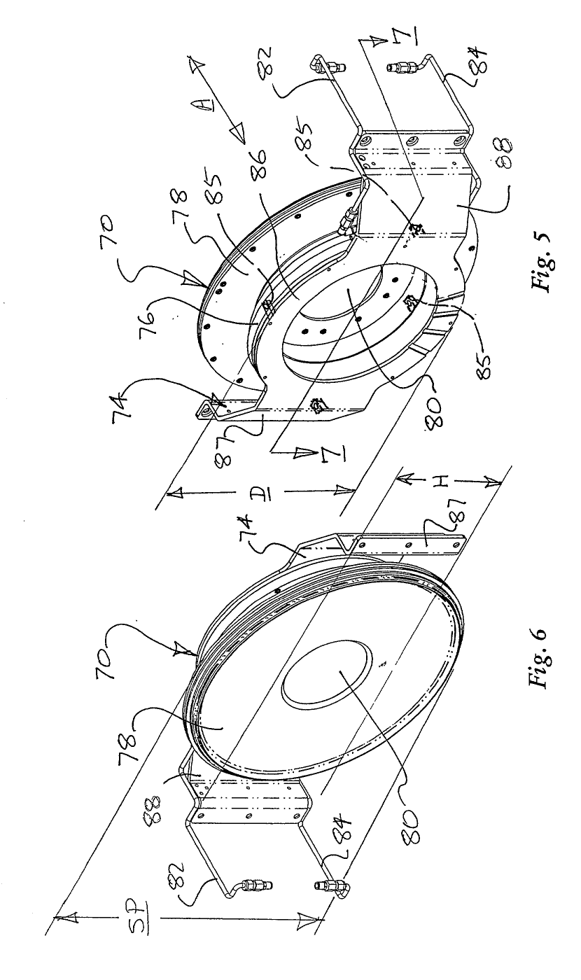

A door system, generally designated 68 includes a door plate assembly 70, as shown in FIGS. 5 and 6. Referring to FIGS. 4-6, the door plate assembly 70 includes a mounting plate 74. A door seal actuator is attached to the mounting plate 74, and moves a closure plate or plug 78 axially (in direction A) shown in FIG. 5, to engage and disengage or separate the closure plate 78 from the open front end 65 of the chamber 52.

As shown in FIG. 4, a door cover 72 is attached to the mounting plate 74. Preferably, the door cover 72 is a cosmetic cover which can be quickly and easily removed, e.g., via fasteners 75.

As shown in FIGS. 5-7, the closure plate 78 includes a centrally located transparent window 80, which allows visual inspection of the workpieces and interior of the chamber 52, during processing of workpieces. A door seal 100 is attached to the box surface of the closure plate 78. A window plate 104 is attached to the front surface of the closure plate 78, and secures the window 80 in place.

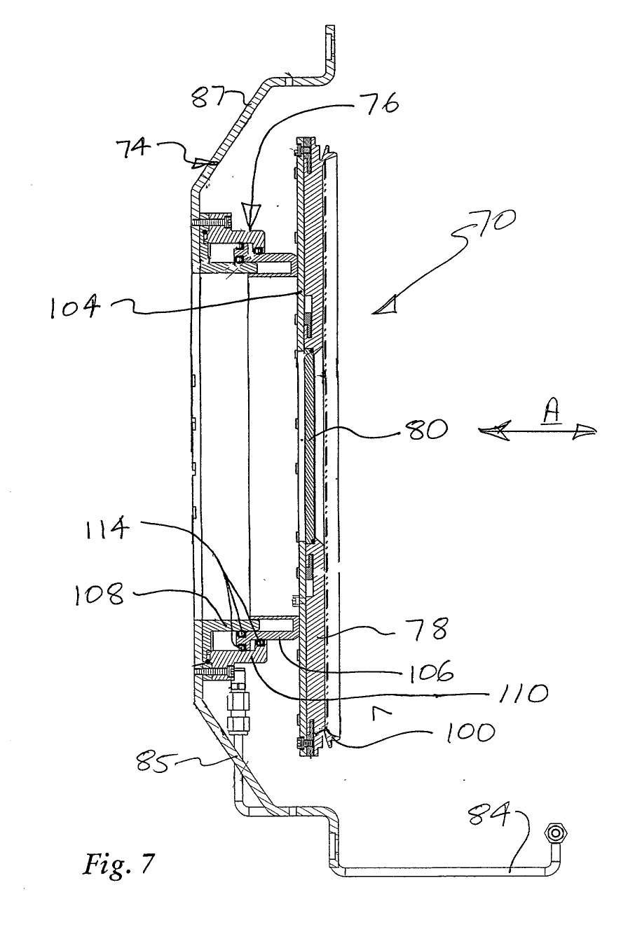

The closure plate actuator 76 preferably is pneumatically driven, although other types of actuators may also be used. As shown in FIG. 7, the closure plate actuator 76 advantageously includes a piston 106 axially movable in direction A between and inner cylinder 108 and an outer cylinder 110. Sliding seals 114 provide a substantially air tight seal between the piston 106 and cylinders 108 and 110. As shown in FIGS. 5 and 6, compressed gas or air lines 82 and 84 connect through the cylinders 108 and 110, on opposite sides of the sliding seals 114 on the piston 110.

Referring to FIG. 4, a closure plate position sensor 92 is supported on the mounting plate 74, to detect a position of the closure plate 78.

Referring to FIGS. 5 and 6, the mounting plate 74 has legs 87 and 88 extending outwardly from an annular center section 86. The closure plate actuator 76 is attached to the center section 86 of the mounting plate 74. The legs 87 and 88 are preferably generally rectangular (when viewed from the front). The legs extend rearwardly, towards the chamber 52 from the plane of the center section 86. The height H of the legs 87 and 88 is less than the diameter or height D of the center section 86 of the mounting plate 74, and also less than the height, vertical dimension, or diameter SP of the closure plate 78, as shown in FIGS. 5 and 6. Preferably, the height H of the legs 87 and 88 is less than 80, 70, 60, or 50% of the height D of the center section 86 of the mounting plate 74. The height H of the legs 87 and 88 is also preferably less than 50, 40, or 30% of the height, vertical dimension, or diameter SP of the closure plate 78.

Closure plate adjustment screws 85 on the mounting plate 74 are provided to adjust the alignment of the closure plate 78 with the front opening 65 of the chamber 52. Alternatively, the adjustment screws 85 may be provided on the closure plate actuator 76, to directly position the closure plate 78.

Referring to FIGS. 3 and 4, the support plates 64 on opposite sides of the chamber 52 are attached to lift actuator mounting plates 90. A lift actuator 95 is attached to each lift actuator mounting plate 90. Each lift actuator 95 has a piston 96 movable within a cylinder 97. A piston follower 98 on the outside of the cylinder 97 is magnetically coupled with and driven by the piston 96. The piston 96 is preferably moved within the cylinder 97 by introducing a compressed gas or air into the cylinder 97, above or below the piston 96. Side panels 94 are attached to the support plates 64 in front of the lift actuators 95.

In use, workpieces 20 are placed into the system 10 at the input/output station 14. The workpieces may be held within a cassette, carrier, or tray, as shown in FIG. 1. The workpieces are temporarily stored at the indexer 16. At an appropriate time, the process robot 22 moves the workpieces 20, either alone, or within a cassette, and moves them to a processor 30 in the process section 26.

The door system 68 is in the down or open position, shown in dotted lines in FIG. 3. The process robot 22 places the workpieces into the chamber 52. The lift actuators 95 then to lift the door assembly 70 to the up position, shown in solid lines in FIG. 3. The closure plate actuator 76 then moves the closure plate 78 into engagement with the open front end 65 of the chamber 52, to close off the chamber. Preferably, the chamber is also sealed via engagement of the door seal 100 against the chamber 52, to prevent escape of liquid or gases out of the chamber 52 via the front opening 65. The design and operation of the closure plate actuator 76, as well as the movement of the lift actuators 90, is described in part in U.S. Pat. No. 5,575,641, incorporated herein by reference.

The engagement of the closure plate 78 and the seal 100 against the chamber 52 largely prevents escape of liquids, gases or vapors from the chamber during processing. After processing is completed, and gases, liquids or vapors within the chamber 52 are evacuated via drain lines or other connections, the closure plate actuator 76 moves in the reverse or forward direction, disengaging or separating the closure plate 78 from the chamber 72. The lift actuators 90 then move the door assembly 70 back down to the position shown in dotted lines in the FIG. 3. The process robot 22 then returns to the processor 30 to remove the workpieces 20 from the now open chamber 52. The process robot 22 moves the workpieces to another processor 30 of the system 10, or returns the workpieces 20 to the indexer 16.

Referring to FIG. 5, the mounting plate 74 has a narrow profile or height. This allows the alignment of the closure plate 78 with the chamber 52 to be more easily visually inspected. Consequently, adjusting the alignment between the closure plate 78 and the chamber 52, using the adjustment screws 85, is more easily performed. The door cover 72 covers the door assembly 70. However, the door cover 72, while supported on the mounting plate 74, is otherwise independent from the door assembly 70. Consequently, the door cover 72 does not affect or cooperate in operation of the door system 68. The door cover 72 can therefore be removed from the door assembly 70, while the door system 68 is operated, to allow visual inspection of all aspects of operation, movement, position or alignment of the components of the door system 68. Accordingly, the door system 68 is more easily manufactured and maintained.

A novel process system and door system have been shown and described. Various modifications and substitutions may be made without departing from the spirit and scope of the invention. The invention, therefore, should not be restricted, except to the following claims and their equivalents.

1. A processor comprising:
a process chamber;
a door system for opening and closing the process chamber, with the door system comprising:
a mounting plate having first and second legs joined on opposite sides of a center section having a height H, with at least one of the first and second legs having a height less than H;
an actuator on the mounting plate; and
a seal plate attached to the actuator and moveable by the actuator to engage the process chamber to close the process chamber, and with the seal plate moveable by the actuator away from the process chamber, to open the process chamber.

2. The processor of claim 1 further comprising a cover attached to the mounting plate and covering the first and second legs and the center section of the mounting plate.

3. The processor of claim 1 further comprising a door position sensor attached to the first leg of the mounting plate.

4. The processor of claim 1 further comprising a first lift actuator attached to the first leg of the mounting plate and a second lift actuator attached to the second leg of the mounting plate.

5. The processor of claim 4 wherein the first and second lift actuators each have a piston moveable within a cylinder and magnetically coupled to a piston follower outside of the cylinder, and with the piston follower of the first lift actuator attached to the first leg of the mounting plate, and with the piston follower of the second lift actuator attached to the second leg of the mounting plate.

6. The processor of claim 1 where the center section of the mounting plate is circular.

7. The processor of claim 6 where the height of the first leg is less than 80% of the height of the center section.

8. The processor of claim 7 where the height of the first leg is less than 60% of the height of the center section.

9. The processor of claim 2 where the process chamber has an open front end and wherein the cover covers the open front end of the chamber.

10. The processor of claim 2 where the cover comprises a cosmetic cover and does affect operation of the door system, so that the cover can be removed to view and adjust operation of the door system.

11. A processor for processing a workpiece, comprising:
a process chamber having an open front end;
a door system for closing off the open front end of the process chamber, during processing, with the door system including:
a door plate assembly having a mounting plate, a chamber closure plate, a chamber closure plate actuator on the mounting plate linked to the closure plate, for engaging and disengaging the closure plate with the open front end of the process chamber, and a cover covering the mounting plate and the closure plate; and
at least one door plate assembly lift actuator attached to the mounting plate.

12. The processor of claim 11 wherein the mounting plate has a pair of legs attached to a center section.

13. The processor of claim 12 where at least one of the legs has a vertical dimension H and the center section has a vertical dimension D, and where H is less than D.

14. The processor of claim 11 wherein the at least one door plate assembly lift actuator comprises a piston in a cylinder magnetically linked to piston follower outside of the cylinder, and with the mounting plate connected at least indirectly to the piston follower.

15. The processor of claim 12 further comprising a door plate assembly lift actuator connected to each of the legs of the mounting plate.

16. The processor of claim 11 further comprising a chamber closure position sensor on the mounting plate and covered by the cover plate.

17. The processor of claim 11 wherein the cover plate covers the open front end of the process chamber.

18. The processor of claim 12 wherein the chamber closure plate actuator is annular and the center section of the mounting plate is annular and concentric with the chamber closure plate actuator.

19. The processor of claim 18 wherein at least one of the legs has a vertical dimension H and the center section has a diameter D which is greater than H.

20. A processor for processing a workpiece, comprising:
a process chamber having an open front end;
a door means for closing off the open front end of the process chamber, during processing, with the door means including a chamber closure plate, means for engaging and disengaging the chamber closure plate with the open front end of the process chamber, alignment means for aligning the chamber closure plate with the open front end of the process chamber and for moving the chamber closure plate away from the open front end of the process chamber, and a cover covering the means for engaging and disengaging, and with the means for engaging and disengaging operable with or without the cover in place.

21. A system for processing a workpiece, comprising:
an interface section and a process section within an enclosure;
a process robot moveable between the interface section and the process section;
at least one workpiece processor in the process section, with the workpiece processor comprising:
a process chamber having an open front end;
a door system for closing off the open front end of the process chamber, during processing, with the door system including:
a door plate assembly having a mounting plate, a chamber closure plate, a chamber closure plate actuator on the mounting plate linked to the closure plate, for engaging and disengaging the closure plate with the open front end of the process chamber, and a cover attached to the mounting plate and covering the mounting plate and the closure plate; and at least one door plate assembly lift actuator attached to the mounting plate.

22. A method for adjusting alignment of a door assembly used to seal off a process chamber during processing of a workpiece with liquids, gases or vapors, comprising the steps of:
removing a cover from the door assembly;
inspecting the fit of a chamber closure plate at least one side of the process chamber, behind a mounting plate of the door assembly;
adjusting the position of the chamber closure door assembly relative to the process chamber; and
reinstalling the cover of the door assembly.
